(19) United States
(12) Patent Application Publication
(10) Pub. No.: US 2018/0157478 A1
(43) Pub. Date: Jun. 7, 2018

(54) DEPLOYMENT OF IMMUTABLE WEB APPLICATION BUILDS

(71) Applicant: COURSERA, INC., Mountain View, CA (US)

(72) Inventors: Jonathan WONG, Mountain View, CA (US); Bryan KANE, San Francisco, CA (US); Brennan SAETA, Menlo Park, CA (US)

(21) Appl. No.: 15/368,077

(22) Filed: Dec. 2, 2016

(51) Int. Cl. G06F 9/445; H04L 29/08; G06F 9/44

(52) U.S. Cl. CPC G06F 8/65; G06F 8/71; H04L 67/34

(57) ABSTRACT

In one general aspect, a method can include receiving, by a server and from a computing device, a request for a web application, accessing, by the server, a real-time database responsive to receiving the request, identifying a version of the web application for deployment to the computing device, and identifying at least one criterion for the deployment of the identified version of the web application. The method can further include, based on determining that the at least one criterion for deployment of the identified version of the web application is fulfilled by the requester, retrieving the identified version of the web application from the real-time database, and providing the identified version of the web application to the computing device.

### TECHNICAL FIELD

This description generally relates to managing and deploying a large number of immutable versions of a web application.

### BACKGROUND

A provider of a web application can make periodic updates to the web application by making incremental changes to the web application. For example, an update to a web application can provide additional functionality for the web application. In another example, an update to a web application can fix one or more errors or issues for the web application. The deployment (rollout) of the updated (or new) web application to a production environment (e.g., the public at large) can provide a user with increased functionality and/or corrections for existing problems with the web application. In some cases, however, the updated (or new) web application can include errors that are not identified until the actual deployment of the web application to the production environment. Because of the incremental changes made to the web application before the deployment, a provider of the web application would need not only need to identify the source of the errors but would need to generate another version of the web application that may not include the identified errors.

### SUMMARY

According to one general aspect, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a computer-implemented method can include receiving, by a server and from a computing device, a request for a web application, accessing, by the server, a real-time database responsive to receiving the request, identifying a version of the web application for deployment to the computing device, identifying at least one criterion for the deployment of the identified version of the web application, and based on determining that the at least one criterion for deployment of the identified version of the web application is fulfilled by the requester, retrieving the identified version of the web application from the real-time database, and providing the identified version of the web application to the computing device.

Implementations can include one or more of the following features, alone or in combination with one or more other features. For example, the identified version of the web application can be a current version of the web application. The identified version of the web application can be an immutable version of the web application. The real-time database can include a plurality of immutable versions of the web application. The method can further include receiving, by a server and from another computing device, a request for a web application, based on determining that at least one criterion for deployment of the version of the web application is not fulfilled by the requester, retrieving another version of the web application from the real-time database, and providing the other version of the web application to the computing device. The other version can be a test version of the web application. Identifying a current version of the web application can include accessing, by the server, a web application version list included in the real-time database. The web application version list can identify a version of the web application stored in the real-time database as the current version of the web application. The web application version list can include a plurality of versions of the web application. Each of the plurality of versions of the web application can have associated metadata providing information about the version of the web application. Two or more of the plurality of versions of the web application included in the web application version list can be deployed at the same time. The deployment of the two or more of the plurality of versions of the web application can occur in real time. Each of the plurality of versions of the web application can be immutable versions of the web application.

In another general aspect, a computer-implemented method can include providing, by a server and to a computing device, source code for a web application included in a source code repository, receiving, by the server and from the computing device, modified source code for a first version of the web application, the modified source code being marked for review, building the first version of the web application, storing the first version of the web application in a version repository, the first version of the web application being designated as a test version, receiving an indication that the first version of the web application is set as an override targeting the first version of the web application for testing in a production environment, and based on receiving an indication that the first version of the web application is approved for deployment, building a second version of the web application, the second version including the modified source code merged with master source code for the web application, storing, by the server and in a real-time database, the second version of the web application, and adding the second version of the web application to a web application version list included in the real-time database, the adding including providing at least one criteria for the deployment of the second version of the web application.

Implementations can include one or more of the following features, alone or in combination with one or more other features. For example, the second version of the web application can be designated for deployment to a general public. The method can further include receiving, by a server and from a computing device, a request for source code for the web application, and accessing, by the server, the source code repository.

In yet another general aspect, a system can include a real-time database configured to store a plurality of immutable versions of a web application for deployment to at least one computing device, and store a web application version list including information associated with each of the plurality of stored immutable versions of the web application. The system can include a request server configured to receive a request for a version of the web application, identify a version of the web application for deployment to the at least one computing device, the identifying based on the information associated with the version of the web application included in the web application version list, and deploy the version of the web application to the at least one computing device. The system can include an error server configured to monitor execution of the web application on the at least one computing device, and provide errors related to the execution of the web application on the at least one computing device.

Implementations can include one or more of the following features, alone or in combination with one or more other features. For example, the system can further include a build server configured to build each of the plurality of stored immutable versions of the web application. The real-time database can be further configured to update the information included in the web application version list based on input received from the build server. The error server can be further configured to provide the errors related to the execution of the web application on the at least one computing device to the request server. The error server can be further configured to provide the errors related to the execution of the web application on the at least one computing device to the request server as one or more error graphs for storage in the web application version list.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example system for use in building, managing, and deploying versions of a web application.

FIG. 2 is a diagram illustrating example hardware and software modules included in a request server.

FIG. 3 is a diagram illustrating example hardware and software modules included in a build server.

FIG. 4 is a diagram illustrating example hardware and software modules included in an error server.

FIG. 5 is a flowchart that illustrates a method for building, testing, and deploying versions of a web application.

FIG. 6 is a flowchart that illustrates a method for deploying versions of a web application.

FIG. 7 is a diagram showing a basic layout for a deployment dashboard.

FIG. 8 is a diagram showing a detailed page for a deployment dashboard.

FIG. 9 is a diagram showing an option selection for a deployment dashboard.

FIG. 10 is a diagram showing a deploy option button included in a deployment dashboard.

FIG. 11 shows an example of a computer device and a mobile computer device that can be used to implement the techniques described here.

Like reference symbols in the various drawings indicate like elements.

### DETAILED DESCRIPTION

A provider of a web application can generate a new version of the web application for each incremental change made to the web application. In addition, the provider can keep (e.g., store in a repository or database) each version of the web application. Each version of the web application can be a fully encapsulated version of the web application at a particular point in time that incorporates certain identified changes. Each web application can be referred to as an immutable build of the web application. Any changes to the web application are encapsulated in a new or updated build of the web application. For example, the provider may keep (store) thousands of immutable builds (or versions) of the web application. In addition or in the alternative, each version of the web application can be associated with an error graph that includes error statistics for a rollout (deployment) of the version of the web application.

A deployment control application can control the deployment of each version of the web application. The deployment of the web application provides a version of the web application to an identified set of users. In some implementations, the version of the web application can be deployed in a production environment (e.g., the general public) to all users. In some implementations, the version of the web application can be deployed in a production environment to a subset of all users (e.g., ten percent of all users). In some implementations, the version of the web application can be deployed in a test environment before being deployed in a production environment. The deployment of the immutable versions of the web application can be done on a real time basis. For example, the timeframe for the deployment of the immutable versions of the web application can be based on internet latency. Low latency switching between versions of the web application for access by a web browser can be performed, for example, every ten seconds.

The ability to maintain immutable builds of a web application and the ability to manage and control the real time deployment of the immutable builds of the web application can allow the web applications to execute in a production environment in order to obtain further test data. In some implementations, a testing environment for a web application may not run at the same scale as the production environment. Therefore, testing the web application in the test environment may not expose all of the error or bugs that may be in the code for the particular version of the web application. However, performing a massive rollout of the web application only to have users experience numerous problems with the web application is also not desirable. The systems, processes, and methods described herein allow for the rollout (deployment) of a particular version of a web application to particular users, a subset of users, a percentage of users, or all users in a production environment. If errors are encountered because of the rollout, another version of the web application can be rolled out in near real time (based on the latency of the internet) that does not include the errors. In some cases, this dynamic rollout (deployment) of immutable versions of the web application may be transparent to the user.

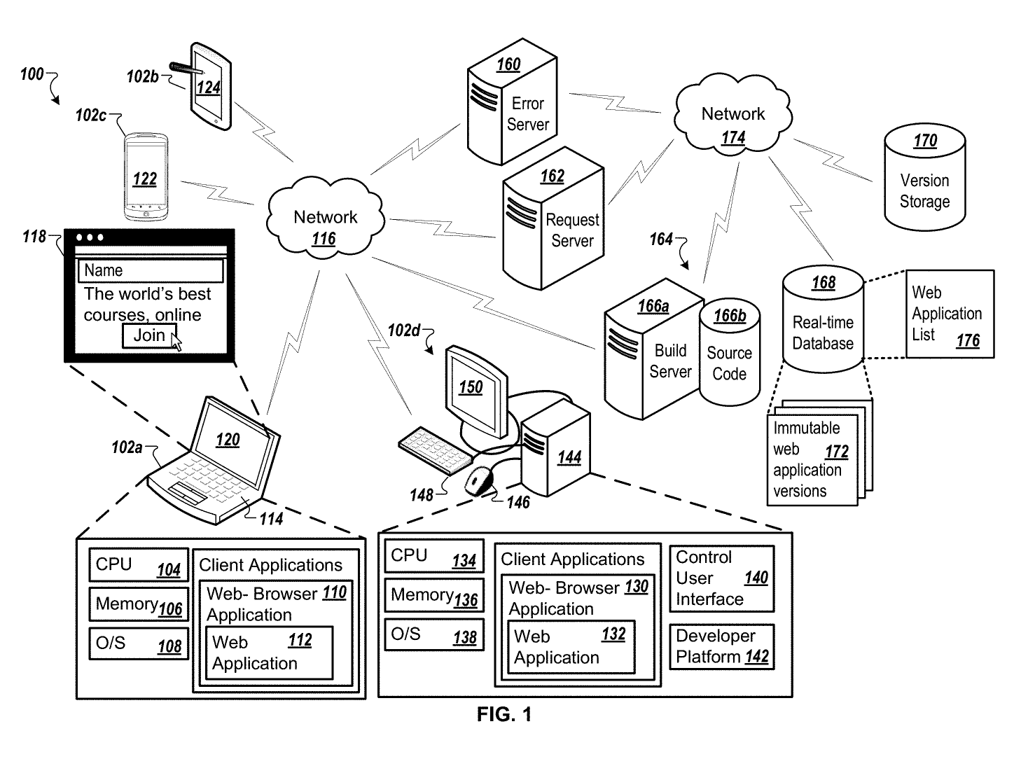

FIG. 1 is a diagram of an example system 100 for use in building, managing, and deploying versions of a web application. The system 100 includes a plurality of computing devices 102a-d (e.g., a laptop or notebook computer, a tablet computer, a smartphone, and a desktop computer, respectively). In some implementations, the computing devices 102a-d can be laptop or desktop computers, smartphones, personal digital assistants, tablet computers, or other appropriate computing devices that can communicate, using a network 116, with other computing devices or computer systems. In some implementations, the computing devices 102a-d can perform client-side operations, as discussed in further detail herein. Implementations and functions of the system 100 described herein with reference to computing device 102a, may also be applied to computing device 102b, computing device 102c, and computing device 102d and other computing devices not shown in FIG. 1 that may also be included in the system 100.

The computing device 102a includes the display device 120 and one or more input devices 114. In a non-limiting example, the one or more input devices can include a keyboard, a trackpad, a pointer button, and mouse buttons. A user can interact with one or more of the input devices to hover over text or icons included in a user interface (e.g., user interface 118) displayed on the display device 120. In some implementations, the display device 120 can be a touchscreen. The user can also interact with the touchscreen to hover over text or icons included in the user interface displayed on the display device 120.

The computing device 102b includes a display area 124 that can be a touchscreen. The computing device 102c includes a display area 122 that can be a touchscreen. The computing device 102d can be a desktop computer system that includes a desktop computer 144, a display device 150 that can be a touchscreen, a keyboard 148, and a pointing device (e.g., a mouse 146). A user can interact with one or more input devices and/or a touchscreen to hover over text or icons included in the user interface displayed on a display device.

The example computing device 102a (e.g., a laptop or notebook computer) can include one or more processors (e.g., a client central processing unit (CPU) 104) and one or more memory devices (e.g., a client memory 106). The computing device 102a can execute a client operating system (O/S) 108 and one or more client applications, such as a web browser application 110. The web browser application 110 can execute one or more web applications (e.g., a web application 112). For example, the web application 112 can be a particular web application deployed by the request server 162 to the computing device 102a.

In some implementations, the web browser application 110 can execute or interpret the web application 112 (e.g., a browser-based application). The web browser application 110 can include a dedicated user interface (e.g., a web browser UI (UI 118)). The web application 112 can include code written in a scripting language, such as AJAX, JavaScript, VBScript, ActionScript, or other scripting languages. The web application 112 can display a web page in the web browser UI 118. For example, the web page can be for a web application that can provide online courses.

The example computing device 102d (e.g., a desktop computer) can include one or more processors (e.g., a client central processing unit (CPU) 134) and one or more memory devices (e.g., a client memory 136). The computing device 102d can execute a client operating system (O/S) 138 and one or more client applications, such as a web browser application 130. The web browser application 130 can execute one or more web applications (e.g., a web application 132). For example, the web application 132 can be a particular web application deployed by the request server 162 to the computing device 102a. The web browser application 130 can operate in a similar manner as the web browser application 110.

The system 100 includes an error server 160, a request server 162, and a build computer system 164 that can include one or more computing devices (e.g., a build server 166a) and one or more computer-readable storage devices (e.g., a source code repository or database 166b). Though shown as a single server in FIG. 1A, the error server 160 can be one or more computing devices working together to perform server-side operations that monitors and tracks errors in a web application. Though shown as a single server in FIG. 1A, the request server 162 can be one or more computing devices working together to perform server-side operations that receive a request for a web application (or a web page) and respond to the request by providing the requested web application (or web page).

In some implementations, a single proprietor can provide the error server 160, the request server 162, and the build computer system 164. In some cases, the one or more of the servers can provide other functionalities for the proprietor. In some implementations, multiple proprietors can provide the error server 160, the request server 162, and the build computer system 164. For example, a third party can provide the error server 160 for use by a proprietor of the request server 162, and the build computer system 164.

In some implementations, the network 116 can be a public communications network (e.g., the Internet, cellular data network, dialup modems over a telephone network) or a private communications network (e.g., private LAN, leased lines). In some implementations, the computing devices 102a-d can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

In some implementations, the network 174 can be a private communications network (e.g., private LAN, leased lines, etc.) allowing selective, monitored, and protected communication between a real-time database 168 and a version repository 170 with the error server 160, the request server 162, and the build server 166a. For example, the computing device 102a may not directly access the real-time database 168 and the version repository 170. The build server 166a can have direct access to the source code repository 166b. The build server 166a may also access the real-time database 168 and the version repository 170. The request server 162 can access the real-time database 168 and the version repository 170. The request server 162 can communicate with the error server 160.

In some implementations, the error server 160 may be given limited access to the servers, databases, and repositories that may be connected to the network 174. For example, the error server 160 can be granted access to the real-time database 168. The error server 160 can be allowed to communicate with (be granted communication privileges with) the request server 162. In some implementations, the error server 160 may not be granted access to (may not be allowed to access) the version repository 170. In some implementations, the error server 160 may not be allowed to communicate with (be granted communication privileges with) the build server 166a. In some implementations, communications may not be enabled (and may not be needed) between the request server 162 and the build computer system 164.

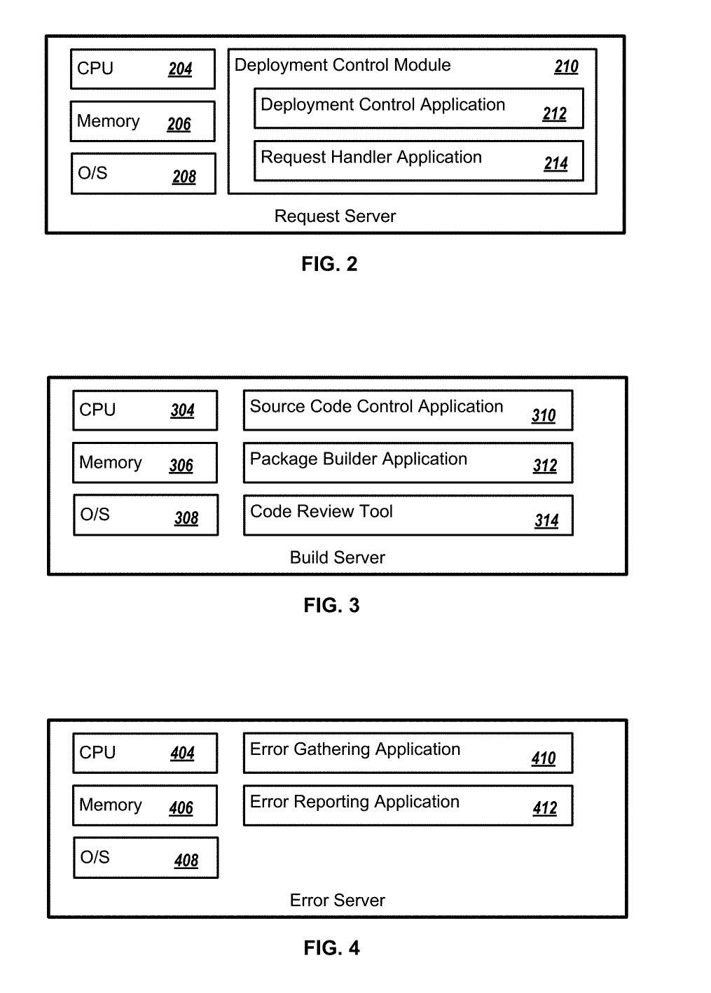

FIG. 2 is a diagram illustrating example hardware and software modules included in a request server (e.g., the request server 162 as shown in FIG. 1). The request server 162 can include one or more processors (e.g., a server CPU 204), and one or more memory devices (e.g., a server memory 206). Referring to FIG. 1, the computing devices 102a-d can communicate with the request server 162 (and the request server 162 can communicate with the computing devices 102a-d) using the network 116. The request server 162 can execute a server O/S 208. The request server 162 can provide one or more immutable web application versions 172 included in (stored in) the real-time database 168 to one or more of the computing devices 102a-d.

The request server 162 includes a deployment control module 210. The deployment control module 210 can include hardware, software, and/or firmware that can be used by the request server 162 to control the deployment of web application versions included in the immutable web application versions 172 stored in the real-time database 168 to any one or all of the computing devices 102a-d. The deployment can occur in real time (e.g., every ten seconds). The time interval for switching the version of the version of a deployed web application can be dependent on an internet latency. The deployment control module 210 can include a deployment control application 212 and a request handler application 214. The deployment control application 212 can control when and how a version of a web application included in the immutable web application versions 172 stored in the real-time database 168 can be deployed to any one or all of the computing devices 102a-d. The request handler application 214 can process (handle) requests for a version (e.g., the current version) of the web application received from a computing device of someone included in the general public. The request handler application 214 can process (handle) requests for a particular version of a web application received from, for example, a computing device of a developer or tester.

The use of a real-time database 168 for storing the immutable web application versions 172 allows for real-time processing of requests for versions of a web application included in the immutable web application versions 172 from computing devices. The real-time processing of the version requests allow for real-time deployment of any of the immutable web application versions 172 to the requesting computing device. Real-time processing allows for the requested version of the web application to occur such that the requested version of the web application included in the immutable web application versions 172 can be deployed to a computing device immediately (without any noticeable delay by a user of the computing device).

The deployment control application 212 can maintain a listing of the available web application versions for deployment (e.g., the immutable web application versions 172). The list (e.g., a web application version list 176) can be stored, for example, in the real-time database 168. The error server 160, the request server 162, and the build server 166a can access and help maintain the web application version list 176. For example, the web application version list 176 can include information (e.g., metadata) associated with the immutable web application versions 172 stored in the real-time database 168.

For example, the information can include, but is not limited to, for each version of a web application included in the version repository 170: error information for each version of the web application; an indication as to the possible deployment of the web application (e.g., the web application can be marked as to whether or not it can be deployed to the general public); an indication marking the web application as obsolete (not for deployment); an indication as to what percentage of the general public the web application can be deployed to; and a date stamp for the web application. The error server 160 can provide the error information. The build server 166a can build a version of the web application and store the web application version in the version repository 170. Once a developer (or reviewer) of the version of the web application approves the web application version for possible deployment (e.g., the developer commits the version of the web application), the build server 166a can store the web application version in the real-time database 168 for possible future deployment. The build server 166a can annotate the web application version list 176 adding information about the web application version (e.g., a version number, a date stamp, a type of possible deployment (e.g., test only, limited public release, full public release, etc.)).

Referring to FIG. 1, in some implementations, a developer can interact with the control user interface 140 to provide input to the deployment control application 212. The developer interacting with the control user interface 140 can provide input the deployment control application 212 for use by the deployment control application 212 for annotating the web application version list 176 to include further information and/or to update information about each of the available web application versions included in the web application version list 176. For example, a first version of the web application included in the web application version list 176 may be marked obsolete. A second version of the web application included in the web application version list 176 may be marked for deployment (full release) to the public and may be considered the current version of the web application. A third version of the web application included in the web application version list 176 may be marked for limited release to the public. For example, only one in every ten users will receive the third version of the web application. The remaining nine users will receive the second version of the web application. The third version of the web application may be a new (and not fully vetted or tested) version of the web application. In some implementations, deployment control application 212 can delete (remove) the version of the web application marked as obsolete from the immutable web application versions 172 stored in the real-time database 168.

Referring to FIG. 1, a user of the computing device 102a interacting with the web browser application 110 can request the web application 112. For example, a user can enter a web page address (a Uniform Resource Locator (URL)) (e.g., www.onlinecourseprovider.org) to access the web application 112 that can run in the web browser application 110. The request server 162 by way of the network 116 can receive the request. The request handler application 214 can determine a version of the web application to provide to the computing device 102a based on one or more criteria. The one or more criteria can be stored in associated with each web application version included in the web application version list 176. For example, the request handler application 214 can determine that all users requesting the web application will receive a particular version (e.g., version one) of the web application. For example, the request handler application 214 can determine that only a subset of all users requesting the web application will receive a particular version (e.g., version one) of the web application. The request handler application 214 can determine that the other users not included in the subset will receive a different version of the web application (e.g., version 2). For example, the request handler application 214 can determine that one in ten users will receive version one of the web application while nine out of ten users will receive version two of the web application.

Referring to FIG. 1, the computing device 102d can send a request to the request server 162 by way of the network 116 for a particular version of a web application included in the version repository 170. For example, a developer may want to test the particular version of the web application. The request handler application 214 can determine that the request received from the computing device 102d is for a computing device of a developer or tester. The request server 162 by way of the network 174 can access the version repository 170 and provide the requested version of the web application to the computing device that made the request. A developer or tester of the web application version included in the version repository 170 can use the computing device 102d to execute and test the web application (e.g., web application 132). In some implementations, the web application under test may be included in the web application version list 176 and annotated accordingly. The error server 160 can gather and report errors associated with the executing of the web application under test on a computing device of the developer. In some implementations, the web application under test may not be included in the web application version list 176. The web application version list 176 can include only versions of the web application that have been reviewed and approved for possible future full or limited deployment. The web application under test may not yet be approved as such, however, the developer may still want to execute and test the web application.

FIG. 3 is a diagram illustrating example hardware and software modules included in a build server (e.g., the build server 166a as shown in FIG. 1). The build server 166a can include one or more processors (e.g., a server CPU 304), and one or more memory devices (e.g., a server memory 306). Referring to FIG. 1, the computing device 102d can communicate with the build server 166a (and the build server 166a can communicate with the computing device 102d) using the network 116. For example, the computing device 102d is an example of a computing device 102d used by a developer of the web application. The build server 166a can execute a server O/S 308.

The build server 166a interfaces with the source code repository 166b in order to access and manage the source code for the web application. A package builder application 312 can build versions of the web application. The developer can specify the source code to include in a build of the web application. The package builder application 312 can manage the source code used for each build of the web application. The package builder application 312 can control the versioning for each build of the web application. The versioning (e.g., version number) and other information (e.g., the source code included in the version and other metadata) associated with a build of the web application can be then stored along with the build of the web application in the version repository 170. The storing of a particular build of the web application can be stored in the version repository 170 based on confirmation from the developer (or someone associated with the development of the code such as a tester or a supervisor).

For example, referring to FIG. 1, a developer can make changes to (updates to) source code for one or more versions of the web application. The developer can use a developer platform 142 included on the computing device 102d when making the updates and changes. The computing device 102d can interface with the build server 166a by way of the network 116. The build server 166a can access the source code for the one or more web applications included in the source code repository 166b. The developer can make the source code changes and send the updated source code to a source code control application 310 for inclusion in the source code repository 166b. The developer can instruct the package builder application 312 to generate a new or updated version of the web application by requesting a build of the web application using specific source code included in the source code repository 166b. The developer can instruct the package builder application 312 (or another application running on the build server 166a) to version the build and commit it to the version repository 170.

A code review tool 314 can be an application that manages the testing and debugging of interim web application versions. For example, before the source code changes for a build or version of a web application are approved, one or more builds of the web application can be tested in a production environment under the control of the developer or tester. The code review tool 314 can manage a listing of the branch of the source code used for a particular build of the web application. A reviewer interacting with a user interface provided to the computing device 102d can set an override in the code review tool 314 for a particular build of the web application that allows the particular build of the web application to be tested in a production environment under the control of the reviewer or developer.

Each version of the web application built by the package builder application 312 and committed to the version repository 170 can be a fully encapsulated stand-alone version of the web application. In some implementations, multiple developers in parallel can be making source code changes and sending updated source code to the source code control application 310 for inclusion in the source code repository 166b. Each developer, in parallel, can instruct the package builder application 312 to generate a new or updated version of the web application by requesting a build of the web application using specific source code included in the source code repository 166b. The developer can instruct the package builder application 312 (or another application running on the build server 166a) to version the build and commit it to the version repository 170. The information and metadata associated with a build of the web application can identify the source code used for the build. Because each build of the web application committed to the version repository 170 is a fully encapsulated stand-alone version of the web application, each build can be deployed under the control of the developers or other persons with the authority to deploy versions of the web application. A version can be deployed to a selected group of users (e.g., the developer, testers, general public, etc.). If there are issues with a particular version of the web application, another version of the web application known not to have issues can be quickly (in real time (e.g., in seconds dependent on internet latencies)) and easily deployed.

Referring to FIGS. 1 and 2, the developer may also be responsible for controlling (specifying) the current publically deployed version of the web application. For example, the developer can use a control user interface 140 included on the computing device 102d to interface with the deployment control application 212 on the request server 162. The control user interface 140 can provide a graphical user interface (GUI) that allows the developer to select a version of the web application included in the version storage for deployment to the public. In addition or in the alternative, the developer interacting with the GUI can indicate what percentage of the public will be deployed a particular version of the web application and what percentage of the public may be deployed another version of the web application. For example, a developer may want to slowly rollout a new version of the web application. The developer, using the GUI, can select the new version of the web application for deployment, indicating that only one in ten users (ten percent of all users) will be provided with the new version of the web application when requesting to use the web application. The developer, using the GUI, can then select another version of the web application (e.g., an older more established version of the web application) for deployment to the other nine of the ten users (ninety percent of all users).

As described, referring to FIG. 1, the web application 112 can include code written in a scripting language, such as AJAX, JavaScript, VBScript, ActionScript, or other scripting languages. The web application 112 can display a web page in the web browser UI 118. In some implementations, the web page for a version of the web application 112 can include information about the version of the build of the web application 112. For example, the web page may be customized to include the version number associated with the build of the web application 112. When access to a particular web page is requested (e.g., the URL for the web page is entered into the web browser application 110), a particular version of a web page for the currently selected build of the web application for deployment to the requester (the user) is returned. As the user navigates the web site for the web application 112, the user will access different web pages associated with the web site (and that are part of the web application 112). Subsequently, based on the customization, the web browser application 110, using scripts running in the web browser application 110, can fetch the correct web page for the particular version of the web application 112.

FIG. 4 is a diagram illustrating example hardware and software modules included in an error server (e.g., the error server 160 as shown in FIG. 1). The error server 160 can include one or more processors (e.g., a server CPU 404), and one or more memory devices (e.g., a server memory 406). The error server 160 can execute a server O/S 408.

An error gathering application 410 can gather errors from web applications executing on computing devices in communication with the error server 160. The error gathering application 410 can associate a version number for the web application reporting the error. An error reporting application 412 can access the real-time database 168 (in real time) and annotate the information and data associated with the web application. The error reporting application 412 can annotate and update the web application version list 176 to include information about the reported error for the associated version of the web application. In some implementations, the error reporting application 412 can access the data and information associated with a version of the web application included in the web application version list 176 to determine the current status of the web application (e.g., current version, past (or old) version, obsolete version, test version, etc.). The error reporting application 412 may not record the error in associated with the version of the web application if the error reporting application 412 determines that the version of the web application reporting the error is an old version of the web application or an obsolete version of the web application (not the current version). In these cases, since there is a newer version of the web application available for deployment to a user, the user may be prompted to reload the web application in order to receive the newer version of the web application.

Referring to FIG. 1, the error server 160 can be in communication with one or more computing devices that are running a version of the web application. For example, the error server 160 can be in communication with computing device 102a (by way of the network 116) that can be running a version of the web application designated for deployment to the general public. For example, the web application 112 running in the web browser application 110 on the computing device 102a can be included in the web application version list 176 and marked as the most recent version for deployment to the general public. The error server 160 can also be in communication with computing device 102d (by way of the network 116) that may be running a version of the web application designated for deployment to developers and testers only (e.g., the web application 132). For example, the web application 132 running in the web browser application 130 on the computing device 102d can be included in the web application version list 176 and marked as the most recent version for deployment to the general public.

The error server 160, and specifically the error gathering application 410, can receive information from computing device 102a (by way of the network 116) about errors encountered while the web application (e.g., the web application 112) was executing in the web browser application 110 on the computing device 102a. The information about each error can include the version number of the web application 112. The error server 160, and specifically the error gathering application 410, can receive information from computing device 102d (by way of the network 116) about errors encountered while the web application (e.g., the web application 132) was executing in the web browser application 130 on the computing device 102d. The information about each error can include the version number of the web application 132. The error server 160, and specifically the error reporting application 412, can store the error information in the real-time database 168 by way of the network 174. The stored error information can be associated with the version number of the build of the web application.

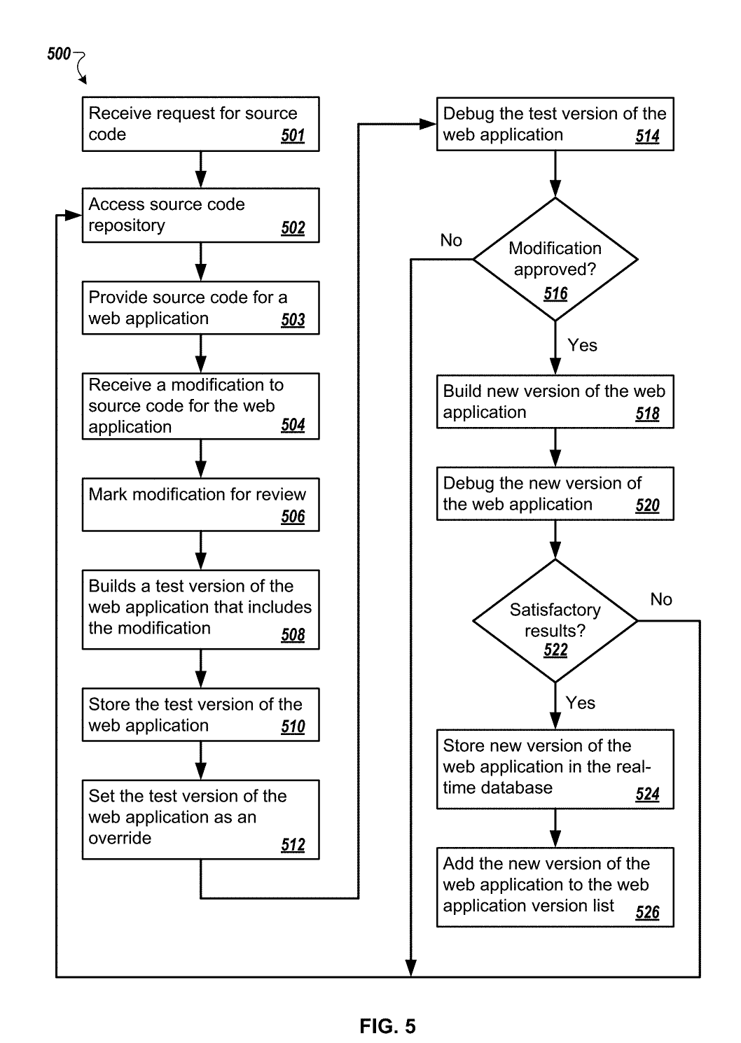

FIG. 5 is a flowchart that illustrates a method 500 for building, testing, and deploying versions of a web application. In some implementations, the systems described herein can implement the method 500. For example, the method 500 can be described referring to FIGS. 1-4.

A request for source code is received (block 501). The source code repository is accessed (block 502). For example, a developer using (interfacing with) the computing device 102d and specifically the developer platform 142 can send a request to the build server 166a for access to a version of the source code included in the source code repository 166b. Source code for a web application is provided (block 503). For example, the source code can be provided to the computing device 102d for use by the developer platform 142, which can update, modify, and otherwise change the source code. A modification to source code for the web application is received (block 504). For example, the developer can make one or more changes to the source code. For example, a developer can change or update source code that controls a color of a web page, changing the color of the web page. For example, a developer can change or update text that is included on a web page. For example, a developer can change or update source code to add one or more a new web pages to the web application.

The modification can be targeted (sent or marked) for a review (block 506). For example, the developer using the developer platform 142 interacting with the source code control application 310 can send the modification for review by a reviewer, the developer, or another developer. Based on marking the modification for review, a build server builds a test version of the web application that includes the modification (block 508). For example, the build server 166a can build a test version of the web application that includes the modified source code. The test version of the web application is stored (block 510). For example, the test version of the web application that includes the modified source code is stored in the version repository 170. The test version of the web application can be an immutable version of the web application that is annotated as a test version (e.g., a name of the test version of the web application can indicate that it is a test version of the web application).

A developer can continue to modify source code for the web application. Each modification can be targeted (sent or marked) for a review and, once marked, the build server can build a version of the web application that includes the modified source code. Each test version of the web application can be stored in the version repository 170.

A test version of the web application can be set as an override (block 512). For example, a reviewer or a developer interfacing with the source code control application 310 can set an override to indicate that a particular test version of the web application can be targeted for testing in a production environment. The reviewer or developer can test the test version of the web application and based on the outcome of the testing, the reviewer to developer can approve the test version of the web application for deployment to the general public. As described, a developer interfacing with a developer platform 142 included on the computing device 102d can request the test version of the web application to run in the web browser application 130. The test version of the web application can be executed and debugged (block 514).

Prior to approval, each build of a version of the web application can be annotated (e.g., named accordingly) to indicate that the version of the web application is a test version of the web application. Test versions of the web application are versions of the web application that have been targeted, sent, or marked for review but have not yet been approved. Based on the outcome of testing, the test version of the web application can be approved for possible rollout to the general public (block 516). Once a test version of the web application is approved, the package builder application 312 included in the build server 166a can build an updated, new version of the web application that includes the source code from the current main branch of the source code (e.g., the master branch) incorporating the marked code changes that were used in the build of the test version of the web application (block 518). In some cases, the new version of the web application may include additional changes to the source code that were not in the original test build. The reviewer or developer can debug the new version of the web application before committing the web application for deployment (block 520).

If the reviewer or developer is satisfied with the test results (block 522), the reviewer or developer can deploy the new version of the web application, including the new version of the web application in the immutable web application versions 172 stored in the real-time database 168 (block 524) and adding the new version of the web application to the web application version list 176 (block 526). If the reviewer or developer is not satisfied with the test results (block 522), the developer can continue to make changes to the source code, accessing the source code repository (block 502). For example, based on the results from the debugging of the new version of the web application, the developer can make, refine, or correct a change to the source code and continue with another build of a test version of the web application.

In some implementations, debugging the new version of the web application (block 520) and determining whether to deploy the new version of the web application based on the results of the debugging (block 522) can be optional. In these implementations, the reviewer or developer can deploy the new version of the web application after the new version of the web application is built.

In addition, if the modification (test version of the web application) is not approved (block 516), the developer can continue to make source code changes, accessing the source code repository (block 502).

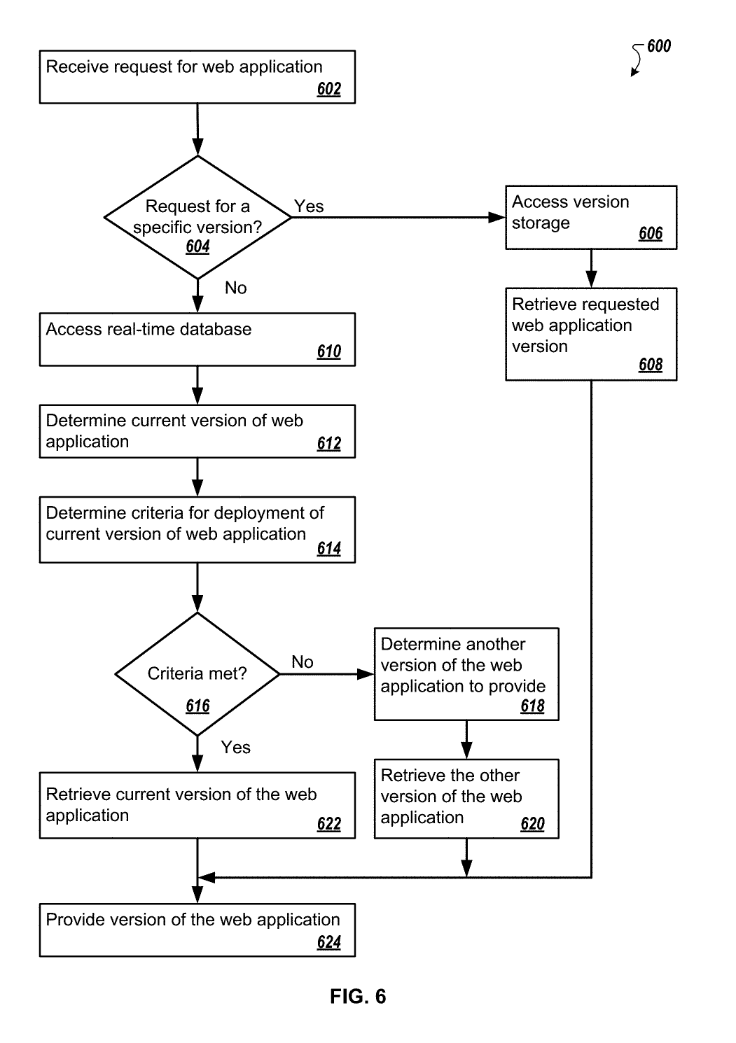

FIG. 6 is a flowchart that illustrates a method 600 for deploying versions of a web application. In some implementations, the systems described herein can implement the method 600. For example, the method 600 can be described referring to FIGS. 1-4.

A request is received for a web application (block 602). For example, referring to FIG. 1, the request server 162 receives a request for a web application (e.g., the web application 112) from the computing device 102a. A general user can interact with the computing device 102a. The request can be for a current version of the web application that is available to the general public. In another example, the request server 162 can receive a request for a web application (e.g., the web application 132) from the computing device 102d. A developer can interact with the computing device 102d. The request can be for a specific version of the web application for testing and debugging by the developer.

It is determined if the request is for a specific version of the web application (block 604). If the request is for a specific version of the web application, a version repository is accessed (block 606). The requested version of the web application (e.g., a test version of the web application) is retrieved from the version repository (block 608). For example, the request server 162 can access the version repository 170 to retrieve the test version of the web application. The test version of the web application requested by the developer can be provided (block 624).

If the request is not for a specific version of the web application, a real-time database is accessed (block 610). A current version of the web application is determined (block 612). For example, the request server 162 can access the real-time database 168. The request server 162 can access the web application version list 176 to determine the current version of the web application for deployment to the general public. Criteria for deployment of the current version of the web application is determined (block 614). For example, the request server 162 can access metadata associated with the current version of the web application for deployment to determine if there are any criteria associated with the deployment. For example, nine out of ten users can be deployed the current version of the web application and one out of ten users can be deployed a test version of the web application. It is determined if the request fulfills the determined criteria (block 616). If the request fulfills the current criteria for deployment of the current version of the web application, the current version of the web application is retrieved (block 622). The retrieved current version of the web application is provided (block 624). For example, if the user request falls into the nine out of ten users category, the current version of the web application can be retrieved from the real-time database (e.g., from the immutable web application versions 172 stored in the real-time database 168). The current version of the web application can be deployed to the computing device of the user. If the request does not fulfill the current criteria for deployment of the current version of the web application, another version of the web application to provide to the user is determined (block 618). The other version of the web application is retrieved (block 620). The other version of the web application is provided (block 624). For example, if the user request falls into the one out of ten users category, a test version of the web application (as noted in the web application version list 176) can be retrieved from the real-time database (e.g., from the immutable web application versions 172 stored in the real-time database 168). The test version of the web application can be deployed to the computing device of the user.

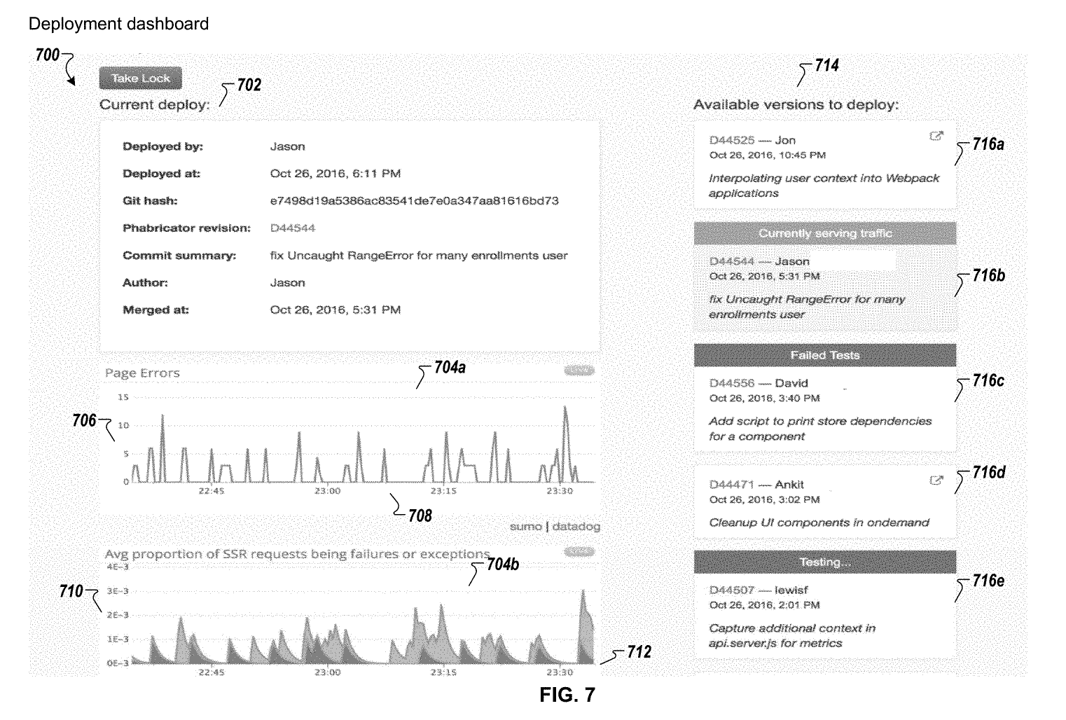

FIG. 7 is a diagram showing a basic layout 700 for a deployment dashboard. For example, the deployment dashboard can be the included as part of the control user interface 140, as shown in FIG. 1. The basic layout 700 of the deployment dashboard can include information about the current version of the web application being deployed to the general public (e.g., current deploy 702). Error graphs 704a-b can be displayed in the deployment dashboard. The error graphs 704a-b can provide a graphical representation in real time of error occurrences. For example, error graph 704a shows a number of page errors along a vertical axis 706 over time as shown along a horizontal axis 708. Error graph 704b shows an average proportion of software service requests that are failures or exceptions along a vertical axis 710 over time as shown along a horizontal axis 712. Available versions to deploy column 714 shows web application versions 716a-e. Web application version 716b is the current version of the web application being deployed. Web application versions 716c-d have failed tests. For example, the web application versions 716c-d may no longer be deployed. Web application version 716e can be considered a full version of the web application that has undergone automated tests that were run on the web application version 716e before the web application version 716e was approved to receive traffic from the general public (before the web application version 716e was approved for deployment). In some implementations, a web application version can be deployed to a select number (or a subset) of users included in the general public (e.g., in a production environment) in order to obtain test data for the web application version before deciding to deploy the web application as a possible current version of the web application.

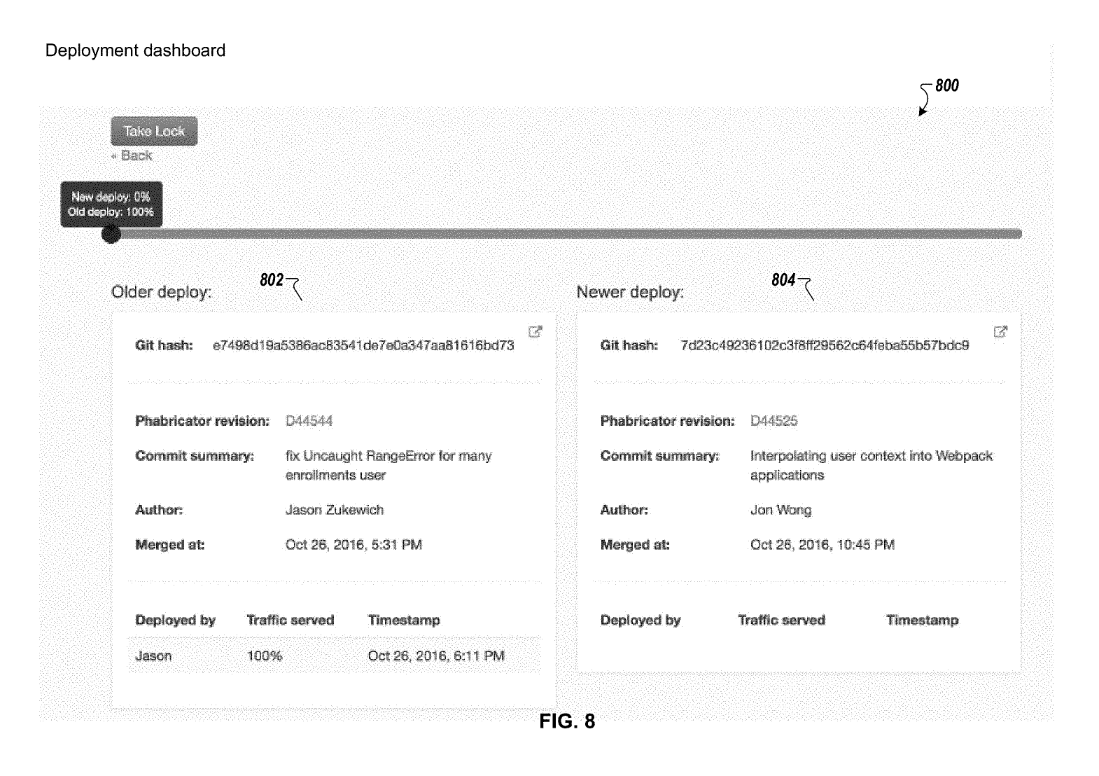

FIG. 8 is a diagram showing a detailed page 800 for a deployment dashboard. For example, the deployment dashboard can be the included as part of the control user interface 140, as shown in FIG. 1. The detailed page 800 includes information about the rollout of two different versions of a web application. For example, a first version of the web application 802 is an older deployed version of the web application. A second version of the web application 804 is a newer deployed version of the web application.

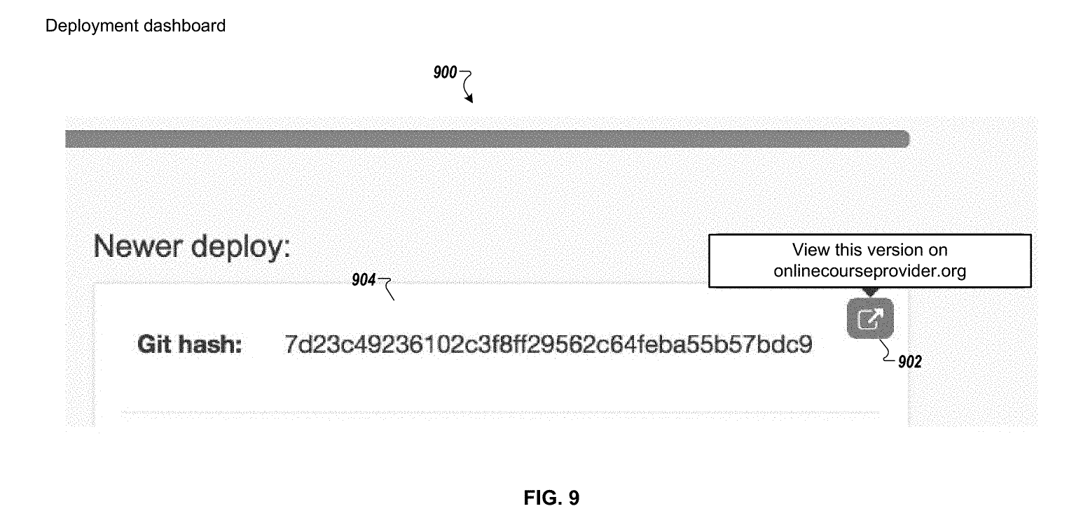

FIG. 9 is a diagram showing an option selection 900 for a deployment dashboard. For example, the deployment dashboard can be the included as part of the control user interface 140, as shown in FIG. 1. A developer can interact with the control user interface 140 and select an option selection button 902. The option selection 900 provides the option selection button 902 that, if selected, allows a test version of a web application (e.g., test version 904) to be viewed in a web browser application without rolling the test version 904 into production (e.g., without deploying the test version 904 to a production environment.

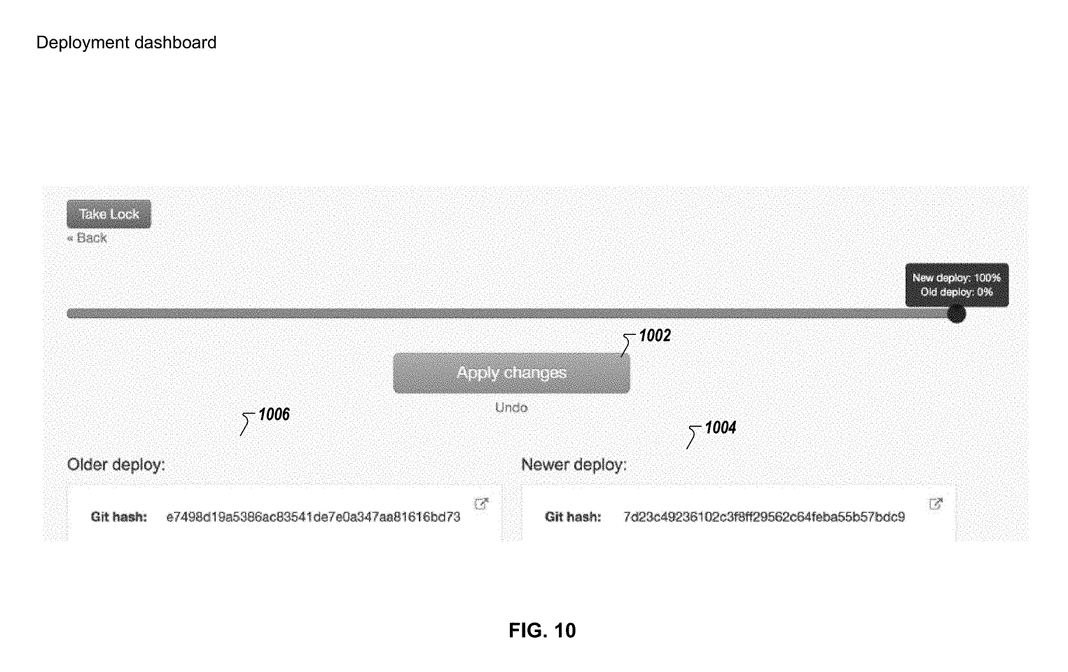

FIG. 10 is a diagram showing a deploy option button 1002 included in a deployment dashboard. For example, the deployment dashboard can be the included as part of the control user interface 140, as shown in FIG. 1. A developer can interact with the control user interface 140 and select the single deploy option button 1002 to quickly and easily apply changes by deploying a newer version of a web application (e.g., newer deploy 1004) as compared to an older version of the web application (e.g., older deploy 1006).

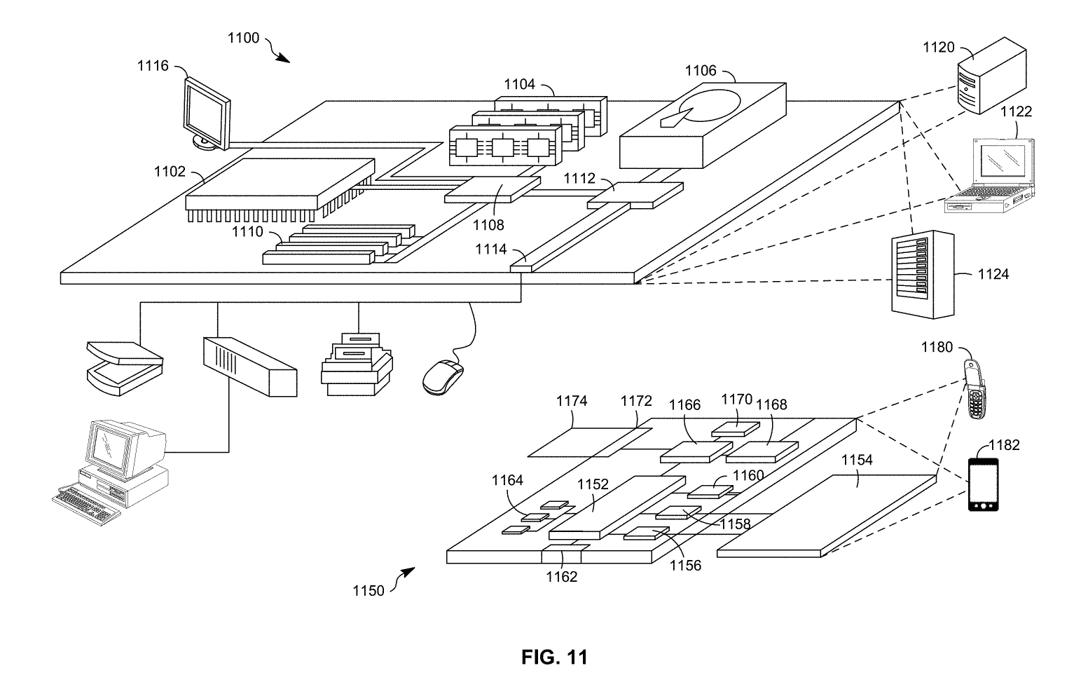

FIG. 11 shows an example of a generic computer device 1100 and a generic mobile computer device 1150, which may be used with the techniques described here. Computing device 1100 is intended to represent various forms of digital computers, such as laptops, desktops, workstations, personal digital assistants, servers, blade servers, mainframes, and other appropriate computers. Computing device 1150 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1100 includes a processor 1102, memory 1104, a storage device 1106, a high-speed interface 1108 connecting to memory 1104 and high-speed expansion ports 1110, and a low speed interface 1112 connecting to low speed bus 1114 and storage device 1106. Each of the components 1102, 1104, 1106, 1108, 1110, and 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as display 1116 coupled to high speed interface 1108. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1104 stores information within the computing device 1100. In one implementation, the memory 1104 is a volatile memory unit or units. In another implementation, the memory 1104 is a non-volatile memory unit or units. The memory 1104 may also be another form of computer-readable medium, such as a magnetic or optical disk.

The storage device 1106 is capable of providing mass storage for the computing device 1100. In one implementation, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1104, the storage device 1106, or memory on processor 1102.

The high speed controller 1108 manages bandwidth-intensive operations for the computing device 1100, while the low speed controller 1112 manages lower bandwidth-intensive operations. Such allocation of functions is exemplary only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer such as a laptop computer 1122. Alternatively, components from computing device 1100 may be combined with other components in a mobile device (not shown), such as device 1150. Each of such devices may contain one or more of computing device 1100, 1150, and an entire system may be made up of multiple computing devices 1100, 1150 communicating with each other.

Computing device 1150 includes a processor 1152, memory 1164, an input/output device such as a display 1154, a communication interface 1166, and a transceiver 1168, among other components. The device 1150 may also be provided with a storage device, such as a microdrive or other device, to provide additional storage. Each of the components 1150, 1152, 1164, 1154, 1166, and 1168, are interconnected using various buses, and several of the components may be mounted on a common motherboard or in other manners as appropriate.

The processor 1152 can execute instructions within the computing device 1150, including instructions stored in the memory 1164. The processor may be implemented as a chipset of chips that include separate and multiple analog and digital processors. The processor may provide, for example, for coordination of the other components of the device 1150, such as control of user interfaces, applications run by device 1150, and wireless communication by device 1150.

Processor 1152 may communicate with a user through control interface 1158 and display interface 1156 coupled to a display 1154. The display 1154 may be, for example, a TFT LCD (Thin-Film-Transistor Liquid Crystal Display) or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may be provide in communication with processor 1152, so as to enable near area communication of device 1150 with other devices. External interface 1162 may provide, for example, for wired communication in some implementations, or for wireless communication in other implementations, and multiple interfaces may also be used.

The memory 1164 stores information within the computing device 1150. The memory 1164 can be implemented as one or more of a computer-readable medium or media, a volatile memory unit or units, or a non-volatile memory unit or units. Expansion memory 1174 may also be provided and connected to device 1150 through expansion interface 1172, which may include, for example, a SIMM (Single In Line Memory Module) card interface. Such expansion memory 1174 may provide extra storage space for device 1150, or may also store applications or other information for device 1150. Specifically, expansion memory 1174 may include instructions to carry out or supplement the processes described above, and may include secure information also. Thus, for example, expansion memory 1174 may be provide as a security module for device 1150, and may be programmed with instructions that permit secure use of device 1150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1164, expansion memory 1174, or memory on processor 1152, that may be received, for example, over transceiver 1168 or external interface 1162.

Device 1150 may communicate wirelessly through communication interface 1166, which may include digital signal processing circuitry where necessary. Communication interface 1166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1168. In addition, short-range communication may occur, such as using a Bluetooth, WiFi, or other such transceiver (not shown). In addition, GPS (Global Positioning System) receiver module 1170 may provide additional navigation- and location-related wireless data to device 1150, which may be used as appropriate by applications running on device 1150.

Device 1150 may also communicate audibly using audio codec 1160, which may receive spoken information from a user and convert it to usable digital information. Audio codec 1160 may likewise generate audible sound for a user, such as through a speaker, e.g., in a handset of device 1150. Such sound may include sound from voice telephone calls, may include recorded sound (e.g., voice messages, music files, etc.) and may also include sound generated by applications operating on device 1150.

The computing device 1150 may be implemented in a number of different forms, as shown in the figure. For example, it may be implemented as a cellular telephone 1180. It may also be implemented as part of a smart phone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving, by a server and from a computing device, a request for a web application;
accessing, by the server, a real-time database responsive to receiving the request;
identifying a version of the web application for deployment to the computing device;
identifying at least one criterion for the deployment of the identified version of the web application; and
based on determining that the at least one criterion for deployment of the identified version of the web application is fulfilled by the requester:
retrieving the identified version of the web application from the real-time database; and
providing the identified version of the web application to the computing device.

2. The method of claim 1, wherein the identified version of the web application is a current version of the web application.

3. The method of claim 1, wherein the identified version of the web application is an immutable version of the web application.

4. The method of claim 1, wherein the real-time database includes a plurality of immutable versions of the web application.

5. The method of claim 1, further comprising:
receiving, by a server and from another computing device, a request for a web application; and
based on determining that at least one criterion for deployment of the version of the web application is not fulfilled by the requester:
retrieving another version of the web application from the real-time database; and
providing the other version of the web application to the computing device.

6. The method of claim 5, wherein the other version is a test version of the web application.

7. The method of claim 1, wherein identifying a current version of the web application includes accessing, by the server, a web application version list included in the real-time database, the web application version list identifying a version of the web application stored in the real-time database as the current version of the web application.

8. The method of claim 7, wherein the web application version list includes a plurality of versions of the web application.

9. The method of claim 8, wherein each of the plurality of versions of the web application have associated metadata providing information about the version of the web application.

10. The method of claim 9, wherein two or more of the plurality of versions of the web application included in the web application version list are deployed at the same time.

11. The method of claim 10, wherein the deployment of the two or more of the plurality of versions of the web application occur in real time.

12. The method of claim 10, wherein each of the plurality of versions of the web application are immutable versions of the web application.

13. A computer-implemented method comprising:
providing, by a server and to a computing device, source code for a web application included in a source code repository;
receiving, by the server and from the computing device, modified source code for a first version of the web application, the modified source code being marked for review;
building the first version of the web application;
storing the first version of the web application in a version repository, the first version of the web application being designated as a test version;
receiving an indication that the first version of the web application is set as an override targeting the first version of the web application for testing in a production environment; and
based on receiving an indication that the first version of the web application is approved for deployment:
building a second version of the web application, the second version including the modified source code merged with master source code for the web application;
storing, by the server and in a real-time database, the second version of the web application; and
adding the second version of the web application to a web application version list included in the real-time database, the adding including providing at least one criteria for the deployment of the second version of the web application.

14. The method of claim 13, wherein the second version of the web application is designated for deployment to a general public.

15. The method of claim 13, further comprising:
receiving, by a server and from a computing device, a request for source code for the web application; and
accessing, by the server, the source code repository.

16. A system comprising:
a real-time database configured to:
store a plurality of immutable versions of a web application for deployment to at least one computing device, and
store a web application version list including information associated with each of the plurality of stored immutable versions of the web application;
a request server configured to:
receive a request for a version of the web application,
identify a version of the web application for deployment to the at least one computing device, the identifying based on the information associated with the version of the web application included in the web application version list, and
deploy the version of the web application to the at least one computing device; and
an error server configured to:
monitor execution of the web application on the at least one computing device, and
provide errors related to the execution of the web application on the at least one computing device.

17. The system of claim 16, further comprising:
a build server configured to build each of the plurality of stored immutable versions of the web application.

18. The system of claim 17, wherein the real-time database is further configured to:
update the information included in the web application version list based on input received from the build server.

19. The system of claim 16, wherein the error server is further configured to provide the errors related to the execution of the web application on the at least one computing device to the request server.

20. The system of claim 16, wherein the error server is further configured to provide the errors related to the execution of the web application on the at least one computing device to the request server as one or more error graphs for storage in the web application version list.
